(19) United States
(12) Patent Application Publication
(10) Pub. No.: US 2004/0132570 A1
(43) Pub. Date: Jul. 8, 2004

(54) Blade tensioner

(75) Inventor: Hiroyuki Takeda, Nabari City (JP)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Morse TEC Japan K.K., Nabari City (JP)

(21) Appl. No.: 10/682,506

(22) Filed: Oct. 9, 2003

Related U.S. Application Data
(63) Continuation-in-part of application No. 10/044,762, filed on Jan. 10, 2002, now abandoned.

(30) Foreign Application Priority Data
Feb. 6, 2001 (JP) 2001-29218

(51) Int. Cl. F16H 7/08; F16H 7/18

(52) U.S. Cl. 474/111; 474/140

(57) ABSTRACT

A blade tensioner includes a blade shoe with an arcuately curved chain sliding face and a plurality of solitary guide pieces upraised from a side edge portion of the chain sliding face in numerous places following the chain sliding face. The blade tensioner also includes a leaf spring-shaped blade spring disposed on the opposite side of the blade shoe from the chain sliding face which applies spring force to the blade shoe. The two guide pieces in a pair of guide pieces are preferably disposed opposite each other on the right side edge and left side edge of the chain sliding face, respectively. Alternatively, the guide pieces are disposed alternately on the right and left side edges of the chain sliding face. Consequently, the blade shoe preferably has either a nearly U-shaped cross section or a nearly L-shaped cross section where the guide pieces are formed.

### REFERENCE TO RELATED APPLICATIONS

This application is a continuation-in-part of copending patent application Ser. No. 10/044,762, filed Jan. 10, 2002, entitled “BLADE TENSIONER”, which claimed an invention which was disclosed in Japanese application number 2001-29218, filed Feb. 6, 2001. The benefit under 35 USC§119(a) of the Japanese application is hereby claimed, and the aforementioned applications are hereby incorporated herein by reference.

### BACKGROUND OF THE INVENTION

1. Field of the Invention

The invention pertains to the field of blade tensioners. More particularly, the invention pertains to a blade tensioner which applies tension to a chain.

2. Description of Related Art

Blade tensioners have been used in the past to apply tension to chains. Generally, blade tensioners comprise primarily a blade shoe made of resin having an arcuately curved chain sliding face and numerous leaf spring-shaped blade springs. The blade springs, which act to apply spring force to the blade shoe, are made of metallic material disposed and stacked on the opposite side of the blade shoe from the chain sliding face.

When the chain is operating, the chain slides and runs on the sliding face. The pushing load accompanying the elastic deformation of the blade shoe and the blade springs is applied to the chain, resulting in tension to the chain. If the chain slackens while operating, blade springs will protrude on the chain side due to the blade spring which elastically deforms to the side where the radius of curvature enlarges, returning and deforming to the side where the radius of curvature decreases so that a uniform tension is maintained on the chain.

In chains used in applications with long link distances, for example in timing chains for driving overhead camshafts of engines, both the length of the slack side span and deflection in the lateral direction of the chain increases so that it is sometimes necessary to guide the chain on the chain sliding face in a lateral direction.

As is shown in FIG. 5(a), which is a cross-sectional view of oil pressure tensioners used in these sorts of applications, guides 51 and 52 extend in the longitudinal direction of the shoe. These guides 51 and 52 are formed on both right and left sides of the edge of chain sliding face 50a of tensioner 50. The deflection of chain 60 in the lateral direction is controlled by these guides and they guide the operation of chain 60.

Although providing guides similar to guides 51 and 52 for blade tensioners has been considered, using these guides 51 and 52 with blade tensioners increases the flexural rigidity of the blade shoe, and the result is that the blade shoe becomes hard to bend. This is a disadvantage because it is generally necessary for a blade shoe to bend with ease in blade tensioners so that the blade shoe can change the curvature radius corresponding to the degree of the chain slacking in order to apply an appropriate tension to the chain at all times. However, if the guide is provided along the entire length of the blade shoe, the blade shoe cannot change to a suitable curvature radius corresponding to the slacking of the chain when the occasion requires it because the blade shoe becomes difficult to bend and an appropriate tension cannot be applied to the chain at all times.

The oil pressure tensioner shown in FIG. 5(b) has guides 51′ and 52′ which extend perpendicularly to the surface of the paper of this drawing formed on both right and left sides of the edge of chain sliding face 50a of the tensioner. In this case, the inner faces 52′a and 53′a of guides 51′ and 52′ are inclined so that it is possible to reduce the flexural rigidity of the tensioner shoe more than with the tensioner shown in FIG. 5(a).

However, this design has the disadvantage that if one endeavors to maintain the respective guides 51′ and 52′ at certain heights, the width W′ of tensioner 50′ becomes slightly larger than the width W of tensioner 50 and the tensioner becomes larger overall. As shown in FIG. 5(c), if the width of the tensioner shoe is reduced to W, then the width of the chain sliding face 5a of tensioner shoe 50″ is also smaller and chain 60 rides up over the respective inner faces 51′a and 52′a of guides 51′ and 52′.

Therefore, there is a need in the art for a blade tensioner which can guide a chain in the lateral direction without increasing the width of the blade shoe.

### SUMMARY OF THE INVENTION

A blade tensioner which imparts tension to a chain includes a blade shoe with an arcuately shaped chain sliding face and a plurality of solitary guide pieces upraised from a side edge portion of the chain sliding face having flat faces, wherein the guide pieces are located along the chain sliding face and the flat faces of the guide pieces come in contact with and guide the chain. The blade tensioner also includes a leaf spring-shaped blade spring, which applies spring force to the blade shoe, disposed on the opposite side of the blade shoe from the chain sliding face.

The two guide pieces in a pair of guide pieces are preferably disposed opposite each other on the right side edge and left side edge of the chain sliding face, respectively. Alternatively, the guide pieces are not in pairs. Instead, the guide pieces are disposed alternately on the right and left side edges of the chain sliding face. Consequently, the blade shoe preferably has either a nearly U-shaped cross section or a nearly L-shaped cross section where the guide pieces are formed. The guide pieces are preferably located in the following three places: a) where the chain begins to contact the chain sliding face, b) where the chain begins to separate from the chain sliding face, and c) in the nearly central position in the longitudinal direction of the chain sliding face. In a preferred embodiment, the chain is either a timing chain for driving a cam shaft of an engine or a chain for driving an auxiliary device of an engine.

### BRIEF DESCRIPTION OF THE DRAWINGS

FIG. 1 shows a simplified schematic drawing of an engine camshaft timing system containing a blade tensioner in an embodiment of this invention.

FIG. 2 shows an oblique view of the blade shoe configuring the blade tensioner.

FIG. 3 shows a cross-sectional drawing of line III-III of FIG. 1.

FIG. 4 shows a cross-sectional drawing of line IV-IV of FIG. 1.

FIG. 5a shows a horizontal cross sectional view of a conventional oil pressure tensioner.

FIG. 5b shows a horizontal cross sectional view of another conventional oil pressure tensioner.

FIG. 5c shows a horizontal cross sectional view of another conventional oil pressure tensioner.

FIG. 6 shows an oblique view of the blade shoe, with guide pieces disposed alternately on right and left side edges of the chain sliding face.

FIG. 7 shows a horizontal cross-sectional view of an embodiment of the blade tensioner of the present invention.

### DETAILED DESCRIPTION OF THE INVENTION

The blade tensioner of the present invention guides a chain in the lateral direction without increasing the width of the blade shoe. In addition, the blade tensioner maintains the ease of bending deformation, or flexibility, of the blade shoe. The blade tensioner also has a guiding feature for the lateral direction of a chain on the chain sliding face of a blade shoe.

A blade tensioner which imparts tension to a chain includes a blade shoe with an arcuately curved chain sliding face and a plurality of solitary guide pieces upraised from side edges of the chain sliding face in numerous places following the chain sliding face. The guide pieces preferably have flat faces, which come in contact with and guide the chain. The blade tensioner also has a leaf spring-shaped blade spring, which applies spring force to the blade shoe, disposed on the opposite side of the blade shoe from the chain sliding face.

While the chain is operating, the chain slides and runs over the chain sliding face of the blade shoe. The guide pieces, which are upraised on the edges of the blade shoe, guide the chain in a lateral direction on the chain sliding face. Likewise, the repulsion force due to the elastic deformation of the blade shoe and the blade spring acts as a pressing load on the chain and uniform tension is imparted to the chain.

The guide pieces which guide the chain are preferably not provided over the entire length of the chain sliding face and are preferably configured from small strip-shaped guide pieces provided in numerous places following the chain sliding face. This design prevents the blade tensioner's flexural rigidity from increasing over the entire length of the blade shoe, prevents the blade shoe from having difficulty in bending, and maintains the blade shoe's flexibility. The result is that the blade shoe can change to a suitable curvature radius when needed. Likewise, the width of the blade shoe is not increased over the entire length of the blade shoe and the width dimension of the chain sliding face can be maintained.

In one embodiment, the two guide pieces of a guide piece pair are preferably disposed opposite each other on the right and left side edges of the chain sliding face, respectively. This creates a U-shaped cross-sectional configuration where the guide pieces are formed. In an alternative embodiment, each of the guide pieces are disposed alternately on right and left side edges of the chain sliding face. This creates an L-shaped cross-sectional configuration where each of the guide pieces are located. These cross-sectional configurations of the blade shoe maintain the width dimension of the chain sliding face and prevent an increase in the width of the blade shoe.

The guide pieces are preferably provided in at least the following three places: a) where the chain begins to contact the chain sliding face, b) where the chain begins to separate from the chain sliding face, and c) the nearly central position in the longitudinal direction of the chain sliding face. When a guide piece is placed where the chain coming from the crank sprocket and entering the blade tensioner begins to contact the chain sliding face of the blade shoe, the chain is guided by the guide piece when the chain leaves the driving sprocket and moves to the blade tensioner, thus entering the chain sliding face smoothly. Likewise, since the nearly central point in the longitudinal direction of the chain sliding face is where the deflection of the chain is the greatest, placing guide pieces here restricts the deflection of the chain in the lateral direction. Finally, when a guide piece is located where the chain begins to separate, when the chain begins to separate and move to the driven sprocket, the chain is guided by the guide pieces to mesh smoothly with the teeth of the driven sprocket.

In a preferred embodiment, the chain is either a timing chain for driving a cam shaft of an engine or a chain for driving an auxiliary device of an engine. A timing chain for driving engine camshafts is ideal as the chain for the blade tensioner of the present invention. Generally, the deflection of timing chains in the lateral direction is relatively greater than that of auxiliary device drive chains which drive auxiliary devices such as oil pumps, since the distance between drive sprockets and driven sprockets is long and the span length on the slack side of a chain is also long. In this case, the deflection of a chain in the lateral direction on a chain sliding face is restricted and the timing chain is guided in a lateral direction by providing numerous guide pieces on the chain sliding face of a blade shoe. However, this blade tensioner may also be applied to chains used for driving an engine's auxiliary devices.

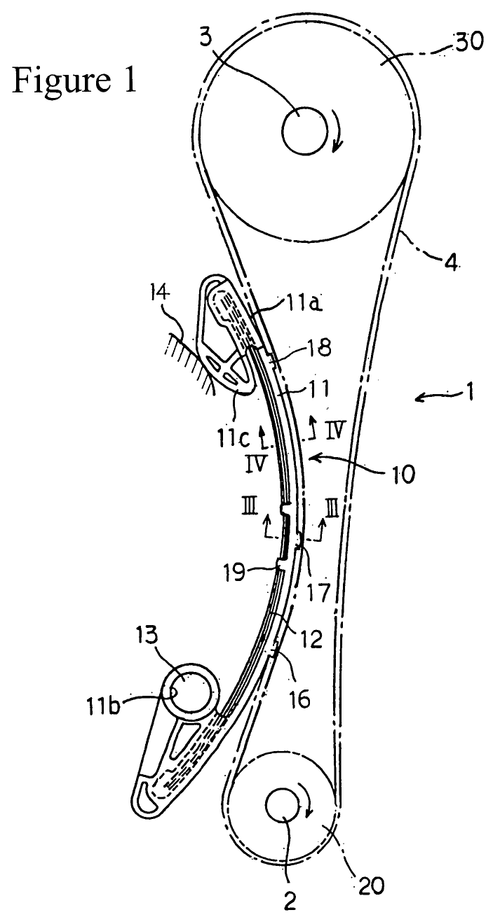

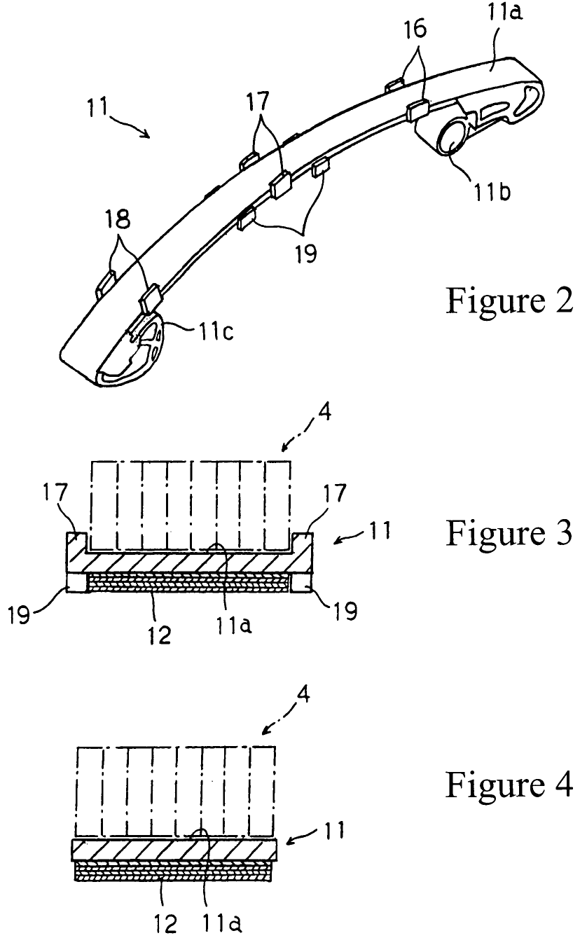

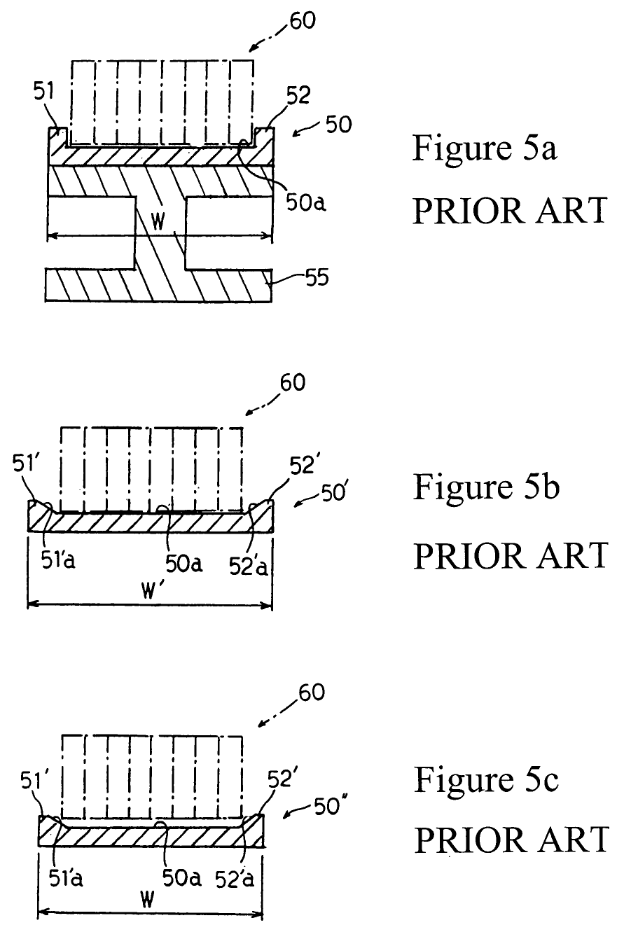

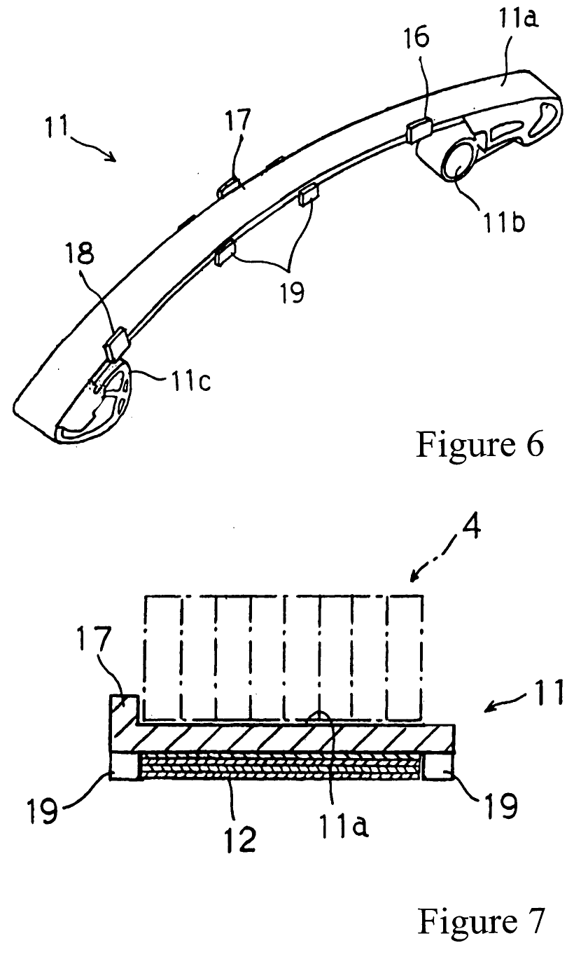

A preferred embodiment of the invention is explained below based on the accompanying drawings. FIG. 1 is a simplified schematic drawing of an engine camshaft timing system containing a blade tensioner in an embodiment of this invention. FIG. 2 is an oblique view of the blade shoe configuring the blade tensioner. FIG. 3 is a cross sectional drawing of line III-III of FIG. 1. FIG. 4 is a cross sectional drawing of line IV-IV of FIG. 1. FIG. 6 is a oblique view of another embodiment of the blade shoe configuring the blade tensioner, with guide pieces disposed alternately on right and left side edges of the chain sliding face. FIG. 7 is a horizontal cross sectional drawing showing an L-shaped cross-section of an embodiment of the blade tensioner of the present invention.

As shown in FIG. 1, the camshaft timing system 1 is outfitted with a crank sprocket 20 secured to crankshaft 2, a cam sprocket 30 secured to camshaft 3, and a timing chain 4 which is wrapped around and hung on these sprockets 20 and 30. Blade tensioner 10 is disposed on the slack side of timing chain 4. The blade tensioner 10 is configured from an arcuately curved blade shoe 11 made of resin, and one or more leaf spring-shaped blade springs 12 for applying spring force to blade shoe 11. The blade springs 12 are disposed stacked on the opposite side of blade shoe 11 from chain sliding face 11a.

Blade shoe 11 is supported so that it may rotate in either direction by a bolt or pin 13 which passes through hole 11b formed on its proximal end. The distal end 11c of blade shoe 11 contacts support face 14 provided in the engine so that it may slide on this support face 14.

While a single overhead camshaft (SOHC) type engine was used as the example in FIG. 1, the blade tensioner of this invention may be applied in the same way to a double overhead camshaft type engine (DOHC). Likewise, it may be applied in the same way to an auxiliary drive chain for driving auxiliary devices such as engine oil pumps which have been used in the past, as well as for timing chains like these. Furthermore, the blade tensioner of this invention is not restricted to engines with a configuration like that shown in FIG. 1; it may be applied to other blade tensioners so long as blade springs are disposed on the side opposite of the blade shoe from the chain sliding face.

As FIG. 2 shows, small guide pieces 16, 17, and 18 upraised from the side edge are placed at specified intervals in the longitudinal direction of chain sliding face 11a on the side edge of chain sliding face 11a. Each of these guide pieces 16, 17 and 18 constitutes a pair of opposite facing guide pieces on both the right and left side edges of chain sliding face 11a. Although the guide pieces 16, 17, and 18 are all shown as guide piece pairs in the figures, they could also be individual guide pieces which alternate on the right and left side edges of the chain sliding face.

Guide pieces 16 are placed where the chain coming from crank sprocket 20 and entering blade tensioner 10 begins to contact the chain sliding face 11a of blade shoe 11 or near it (see FIG. 1). By virtue of this, when chain 4 is running, it is guided by guide pieces 16 when it enters blade tensioner 10. As a result, chain 4 can enter chain sliding face 11a of blade shoe 11 smoothly.

Guide pieces 17 are disposed in nearly the center in the longitudinal direction of chain sliding face 11a (see FIG. 1). This approximate center position is where the deflection of chain 4 on the slack side span of chain 4 is the greatest. Providing guide 17 in this position restricts the deflection of chain 4 in the lateral direction.

Guide pieces 18 are disposed where chain 4 leaving blade tensioner 10 and entering cam sprocket 30 begins to separate from chain sliding face 11a or near it (see FIG. 1). When chain 4 is running, it separates from blade tensioner 10 and is guided by guide piece 18. This allows chain 4 to mesh smoothly with the teeth of sprocket 30.

While the guide pieces are preferably provided in at least the three places described earlier: a) where the chain begins to contact the chain sliding face, b) where the chain begins to separate from the blade tensioner, and c) in the nearly central position in the longitudinal direction of the chain sliding face, it is also possible to provide them in additional places. The number of guide pieces and the size of each guide piece can be suitably determined to correspond to such things as length of the blade shoe, flexibility of the blade shoe, chain length and the amount of the pushing load of the chain.

Likewise, the respective guide pieces need not by disposed opposite facing on both right and left side edges of chain sliding face 11a. Instead, as shown in FIG. 6, they may alternate from the right side edge to the left side edge of the chain sliding face 11a. Moreover, opposite facing guide pieces and alternately placed guide pieces may be mixed. The cross-sectional configuration of blade shoe 11 where two guide pieces form a pair positioned opposite each other is U-shaped (see FIG. 3), while the cross-sectional configuration of blade shoe 11 where individual guide pieces are alternately placed on the left and right side edges of the chain sliding face is L-shaped (see FIG. 7). Where guide pieces are not formed, the cross sectional configuration of blade shoe 11 is rectangular (see FIG. 4). A supporting piece 19, which supports blade spring 12 from a lateral direction, is preferably located on the opposite side of blade shoe 11 from the chain sliding face 11a.

While the chain is operating, chain 4 slides and runs over chain sliding face 11a of blade shoe 11. The respective guide pieces 16, 17 and 18, which are on the side edges of blade shoe 11, guide chain 4 in a lateral direction on chain sliding face 11a. Likewise, the repulsion force due to the elastic deformation of blade shoe 11 and blade spring 12 acts as a pressing load on chain 4 and a uniform tension acts on chain 4.

In this case, the respective guide pieces 16, 17 and 18 guiding chain 4 are not provided over the entire length of chain sliding face 11a and are preferably configured from a plurality of solitary guide pieces which follow a portion of chain sliding face 11a. This prevents the transverse secondary moment over the entire length of blade shoe 11 and hence prevents an increase in its flexural rigidity. This prevents blade shoe 11 from having difficulty in bending deformation, and maintains blade shoe 11's flexibility. The result is that blade shoe 11 can change to a suitable curvature radius when called for corresponding to the degree of slack in chain 4. Likewise, the width of blade shoe 11 is not increased over the entire length of blade shoe 11 and the width dimension of chain sliding face 11a is maintained.

As explained above, with the blade tensioner of this invention, the width dimension of a chain sliding face can be maintained without increasing the width of the blade shoe. The ease of bending the blade shoe is also maintained. A chain can be guided in the lateral direction on the chain sliding face of a blade shoe by the solitary guide pieces provided in numerous places on the side edges of a chain sliding face of a blade shoe.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A blade tensioner for imparting tension to a chain comprising:
a) a blade shoe comprising:
i) an arcuately shaped chain sliding face; and
ii) a plurality of solitary guide pieces upraised from a side edge portion of the chain sliding face having flat faces, wherein the guide pieces are located along the chain sliding face and the flat faces of the guide pieces come in contact with and guide the chain; and
b) at least one blade spring to apply a spring force to the blade shoe, the blade spring being in the shape of a leaf spring and disposed at an opposite side of the blade shoe from the chain sliding face.

2. The blade tensioner of claim 1, wherein the blade shoe has a substantially U-shaped cross-section at each of the guide pieces.

3. The blade tensioner of claim 1, wherein a pair of guide pieces each comprise two guide pieces disposed opposite to each other on a right side edge and a left side edge of the chain sliding face, respectively.

4. The blade tensioner of claim 1 wherein the guide pieces are disposed alternately on a right side edge and a left side edge of the chain sliding face.

5. The blade tensioner of claim 1, wherein the guide pieces are located in at least three positions, wherein these positions comprise:
a) a contact starting position where the chain starts to contact the chain sliding face;
b) a separation starting position where the chain starts to separate from the chain sliding face; and
c) a central position along the chain sliding face.

6. The blade tensioner of claim 1, wherein the chain is a timing chain to drive an engine cam shaft.

7. The blade tensioner of claim 1, wherein the chain is a chain to drive an auxiliary of an engine.

8. The blade tensioner of claim 1, wherein the blade shoe has a substantially L-shaped cross-section at each of the guide pieces.
